(19) United States
(12) Patent Application Publication
(10) Pub. No.: US 2020/0122648 A1
(43) Pub. Date: Apr. 23, 2020

(54) INTERIOR VEHICLE COMPONENT WITH METAL SURFACE ELEMENT AND METHOD FOR PRODUCING THE INTERIOR VEHICLE COMPONENT

(71) Applicant: GRAMMER Interior Components GmbH, Hardheim (DE)

(72) Inventor: Manfred Link, Mudau-Reisenbach (DE)

(21) Appl. No.: 16/594,040

(22) Filed: Oct. 6, 2019

(30) Foreign Application Priority Data
Oct. 18, 2018 (DE) DE102018125910.7

(51) Int. Cl. B60R 13/02; B60Q 3/00; B23K 26/382

(52) U.S. Cl. CPC B60R 13/02; B23K 26/382; B60Q 3/00

(57) ABSTRACT

An interior component of a vehicle, the interior component including a metal surface element that includes at least one graphic feature, wherein the at least one graphic feature is configured as an engraving that is fabricated by material removal, and wherein the engraving includes a micro perforation made from a plurality of boreholes.

### RELATED APPLICATIONS

This application claims priority from German patent application DE 10 2018 125 910.7, filed on Oct. 18, 2018.

### FIELD OF THE INVENTION

The invention relates to an interior vehicle component with a metal surface element that is provided with at least one graphic feature like a logo or symbol.

### BACKGROUND OF THE INVENTION

Generic interior vehicle components with a metal surface element are well known in the art.

The known solutions have the disadvantage that the graphic features typically are not part of the metal surface element, and on the other hand side, that the effect of the graphic configuration is highly dependent on the availability of sufficient daylight.

### BRIEF SUMMARY OF THE INVENTION

Thus, it is an object of the invention to provide a new interior component of a vehicle with a metal surface element wherein the graphic feature does not have the disadvantages described supra.

The object is achieved by an interior component of a vehicle including a metal surface element that is provided with at least one graphic feature like a logo or a symbol, wherein the graphic feature is configured as an engraving that is created by material removal, and wherein the engraving includes a micro perforation made from a plurality of boreholes.

The solution according to the invention has the great advantage on the one hand side that the optical effect or detectability of the graphic configuration during daytime and at night is completely independent from the actual light situation.

Furthermore, the interior component according to the invention has the advantage that the graphic configuration is an integral part of the metal surface element that defines the interior component.

Eventually, it is also advantageous that the fabrication of the graphic feature according to the invention can be implemented in a simple manner in the metal surface element of the interior component using known methods.

Thus, the engraving is configured as an etched engraving in an embodiment of the invention.

By the same token, it is also possible in a simple manner that the micro perforation of the engraving is produced by a laser.

According to an embodiment of the invention, the boreholes of the micro perforation respectively include a diameter of less than 0.1 mm and a distance of the boreholes from each other is also less than 0.1 mm. In this embodiment of the micro perforation optical limits of the human eye with respect to resolution are advantageously reached so that the eye does not see individual light points anymore but a uniformly illuminated surface when the micro perforation of this type is backlit.

In an advantageous embodiment of the invention, however, the boreholes of the micro perforation are provided with a diameter of 0.05 mm and a distance of the boreholes from each other is 0.05 mm.

According to the invention, it is also possible that the engraving of the metal surface element of the interior component is backlit. As a matter of principle, it is also possible that the engraving is partially backlit with different color light.

The invention furthermore also relates to a method for producing a graphic configuration of a metal surface element of an interior component of a vehicle.

Improving upon the art recited supra, the object recited supra is achieved by a method for producing a graphic configuration of a metal surface element of an interior feature of a vehicle, the method including the steps: fabricating an engraving by at least partial material removal on a surface of the metal surface element; and fabricating at least a partial micro perforation that is made from a plurality of boreholes in a portion of the engraving.

The method according to the invention also has the advantage that the graphic feature according to the invention can be introduced into metal surface elements of interior components in a simple manner using known fabrication methods. In this context it is relevant that the micro perforation can be fabricated by a laser.

### BRIEF DESCRIPTION OF THE DRAWINGS

Other advantages of the invention can be derived from the subsequent description of an embodiment with reference to drawing figures, wherein

FIG. 1 illustrates a top view of a portion of a metal surface element of an interior component of a vehicle;

FIG. 2 illustrates a blown-up detail of a graphic feature according to the circular detail II-II in FIG. 1;

FIG. 3 illustrates a detail of a perspective 3-dimensional slanted view of the graphic feature; and

FIG. 4 illustrates a sketch of the metal surface element of an interior component in a sectional view.

### DETAILED DESCRIPTION OF THE INVENTION

In the drawing figures an interior component of a vehicle with a metal surface element is designated overall with the reference numeral 10.

The interior component 10 includes a metal surface element 11 which is provided with a graphic feature 12 configured, e.g., with the word mark GRAMMER 13 and a logo 14.

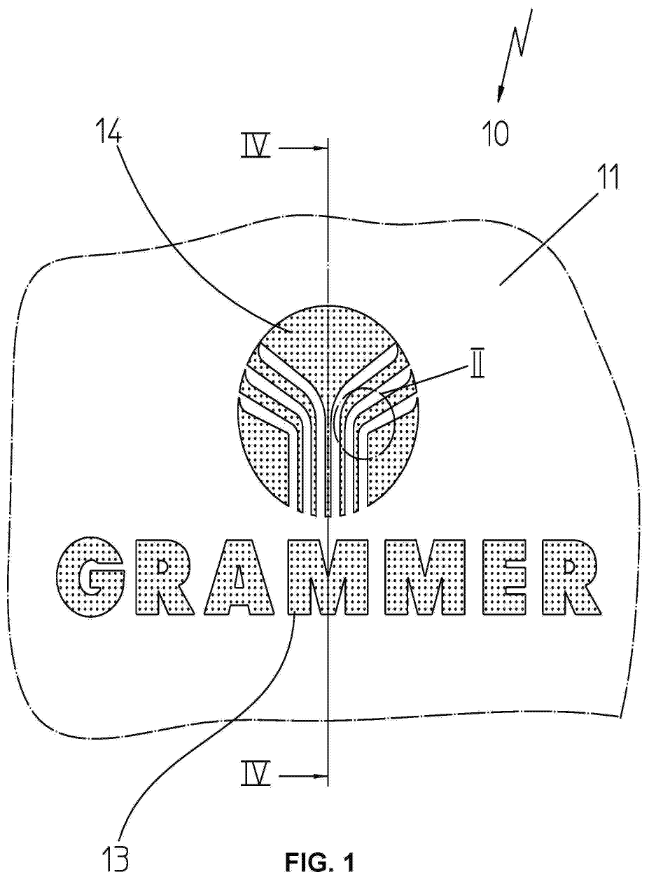

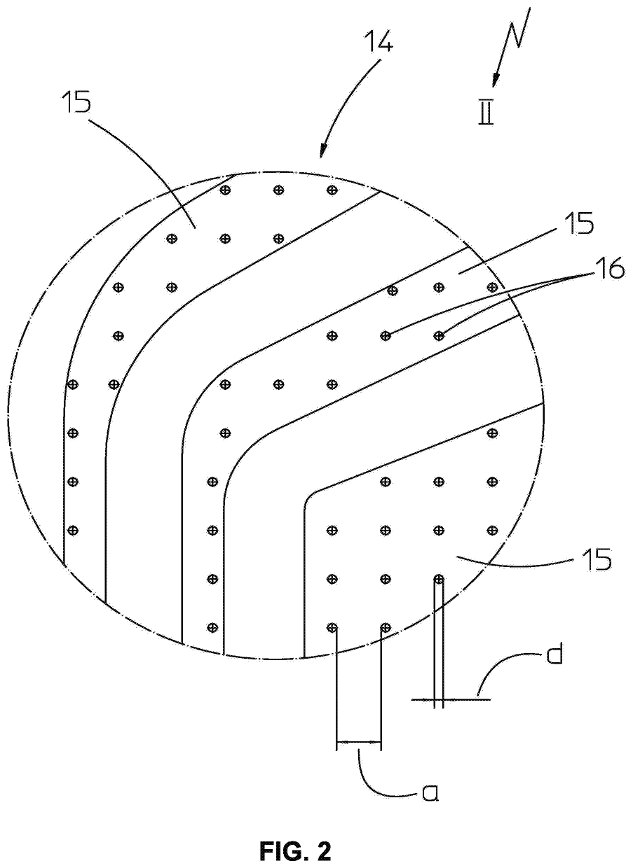

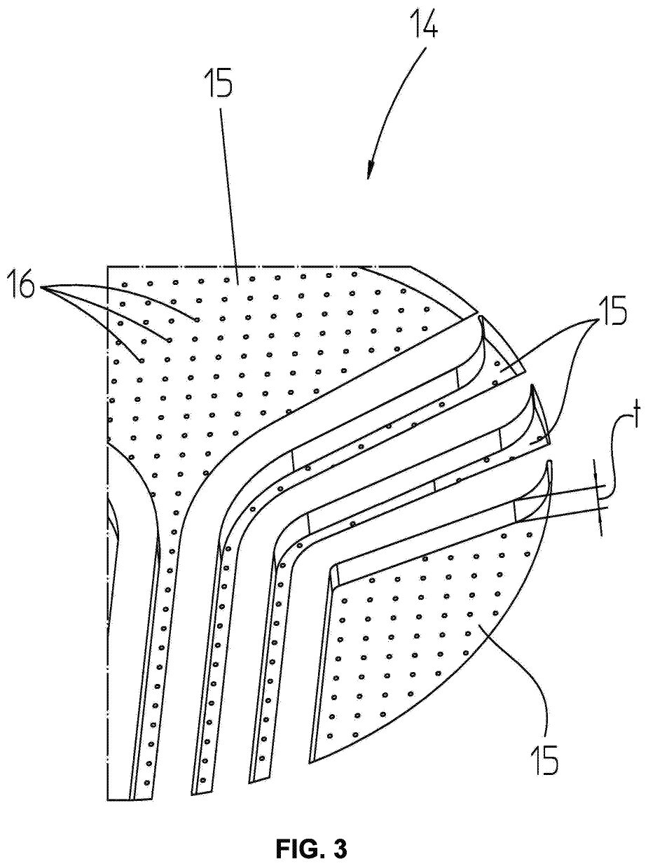

It is evident from a combined view of FIGS. 1, 2 and 3 that the graphic configuration 12 has been engraved into the metal surface element 11 with an engraving depth t. Thus, the engraving of the mark designation GRAMMER 13 and of the fiduciary mark 14 includes engraving base surfaces 15 that are lowered relative to the surface of the metal surface element 11, wherein the engraving base surfaces are respectively provided with a plurality of equidistant boreholes 16 of a micro perforation. According to the embodiment, the boreholes 16 have a diameter d of 0.05 mm wherein a distance a of the boreholes 16 from each other is also 0.05 mm.

While the engraving is advantageously produced by an etching method, the micro perforation can be fabricated into the engraving base surface 15 by lasers after producing the engraving.

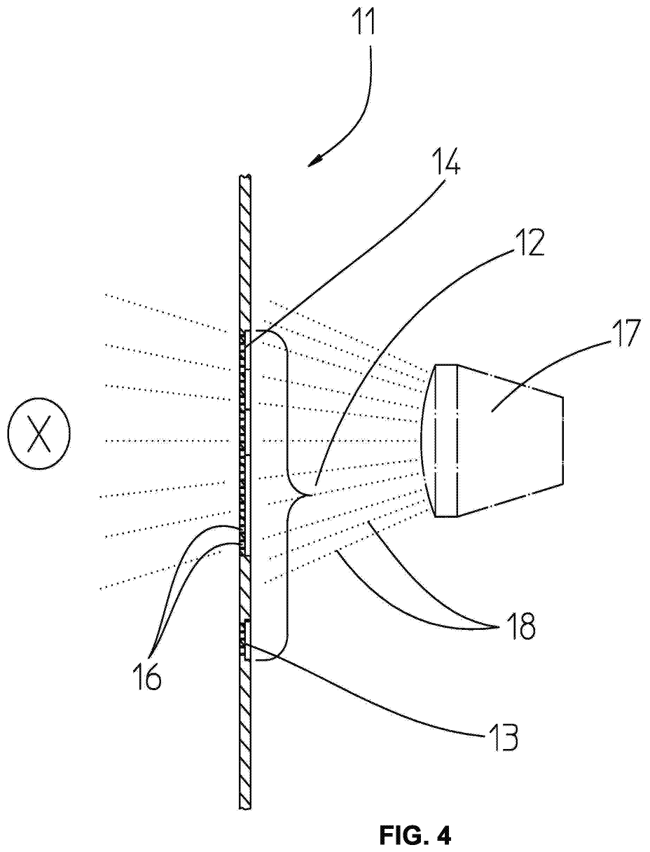

Last not least, the sketch according to FIG. 4 illustrates the sectional view IV-IV through a metal surface element 11 of an interior component 10 of a vehicle wherein the graphic feature 12 that is oriented towards the viewer x is backlit by light 17 that is arranged in the interior component 10.

It is evident that the exemplary illustrated light beams 18 that originate from the light 17 penetrate the boreholes 16 of the micro perforation and generate a surface illuminated graphic feature 12 that is visible to the viewer x.

A graphic feature 12 is clearly visible under daylight due to the engraving fabricated into the metal surface element 11 while the graphic feature 12 is clearly visible in darkness due to the backlit engraving base surfaces 15.

### REFERENCE NUMERALS AND DESIGNATIONS

10 interior component
11 metal surface element
12 graphic feature
13 mark designation GRAMMER
14 fiduciary mark
15 engraving base surface
16 borehole
17 light
18 light beam
x viewer
a distance of boreholes 16 from each other
d diameter of boreholes 16
t engraving depth

What is claimed is:

1. An interior component of a vehicle, the interior component comprising:
a metal surface element that includes at least one graphic feature,
wherein the at least one graphic feature is configured as an engraving that is fabricated by material removal, and
wherein the engraving includes a micro perforation made from a plurality of boreholes.

2. The interior component 10 according to claim 1, wherein the engraving is configured as an etched engraving.

3. The interior component 10 according to claim 1, wherein the engraving is a laser generated micro perforation.

4. The interior component according to claim 1, wherein the boreholes 16 of the micro perforation respectively have a diameter of less than 0.1 mm and a distance of the boreholes 16 from each other is less than 0.1 mm.

5. The interior component 10 according to claim 1, wherein the boreholes 16 of the micro perforation respectively have a diameter of 0.05 mm and a distance of the boreholes 16 from each other is 0.05 mm.

6. The interior component 10 according to claim 1, wherein the engraving is backlit.

7. A method for producing a graphic feature of a metal surface element of an interior component of a vehicle, the method comprising the steps:
fabricating an engraving by at least partial material removal on a surface of the metal surface element; and
fabricating at least a partial micro perforation that is made from a plurality of boreholes in a portion of the engraving.

8. The method according to claim 7, wherein the micro perforation is fabricated by a laser.
